(19) United States
(12) Patent Application Publication
(10) Pub. No.: US 2026/0253240 A1
(43) Pub. Date: Aug. 27, 2026

(54) METHODS OF MEASURING OBJECT DEPTH FROM TWO-DIMENSIONAL IMAGES

(71) Applicant: Purdue Research Foundation, West Lafayette, IN (US)

(72) Inventors: Qi Guo, West Lafayette, IN (US); Junjie Luo, West Lafayette, IN (US); Charles James Wagner, West Lafayette, IN (US); Wei Xu, West Lafayette, IN (US)

(21) Appl. No.: 19/538,085

(22) Filed: Feb. 12, 2026

Related U.S. Application Data
(60) Provisional application No. 63/757,609, filed on Feb. 12, 2025.

(51) Int. Cl. G06T 7/55; G06T 7/73

(52) U.S. Cl. CPC G06T 7/55; G06T 7/74; G06T 2207/20084; G06T 2207/20224

(57) ABSTRACT

Methods of measuring the depth of an object from two-dimensional images of the object. Such a method includes measuring first patch information from a first image in an image capture plane of an edge boundary of an object. The first image includes the edge boundary at a first state of defocus, and the first patch information includes boundaries, color, and blurriness of the first image. Second patch information is then measured from a second image in the image capture plane of the edge boundary. The second image includes the edge boundary at a second state of defocus, and the second patch information includes boundaries, color, and blurriness of the second image. A distance of the object from the image capture plane is then measured from differences in the first and second patch information based on differences of the edge boundary between the first and second states of defocus.

### CROSS-REFERENCE TO RELATED APPLICATIONS

This application claims priority to U.S. Provisional Application 63/757,609 filed Feb. 12, 2025, the contents of which are incorporated herein by reference.

### BACKGROUND OF THE INVENTION

The invention generally relates to methods of extracting usable data from images, and more particularly to methods of measuring the depth of an object from two-dimensional images of the object.

Digital image recognition is a method of obtaining usable data from images of objects. For example, digital image recognition is used to obtain data from video images obtained from a vehicle to make it possible for the vehicle to be driven by a computer rather than a person. One type of data that is often extracted from digital images is the distance of the object from the image capture plane in a camera (e.g., the complementary metal-oxide-semiconductor sensor in a digital camera or the film plane in an analog camera). This distance, also called the “object depth,” can then be used for many different useful calculations in a wide variety of fields and applications.

As used herein, photon-limited images are images obtained under very low light level conditions, often being limited to receiving only a few photons per pixel of the recording mechanism (e.g., an OLED chip). Photon-limited images are frequently encountered in such low-light imaging applications as microscopy and astronomy. As used herein, defocused images are images in which the image is imperfectly focused, thereby resulting in some level of blurriness along edge boundaries in the image depending on the level of defocus.

One method of calculating the object depth of an object in an image is depth from defocus (DfD) methods. DID methods generate physically accurate depth maps without additional active illumination like time-of-flight or structured light, and have a monocular and compact form factor compared to stereo. These advantages make DfD methods suitable for spatially constrained artificial platforms, such as AR/VR, smartphones and watches, miniature robots, and drones. However, DfD methods rely on accurately estimating spatial derivatives in the captured images, a proxy of defocus level, as the depth cue, which is highly susceptible to the image noise. Existing DfD methods typically avoid this issue by assuming low noise levels in the input image.

There are currently two complementary lines of research in DfD. The first utilizes analytical, non-learning-based solutions that estimate partially dense depth maps with minimal computational resources, and the second exploits learning-based models to produce high-quality, dense depth maps with a higher computational cost.

Analytical, non-learning-based solutions leverage the physical relationship between the image derivatives or local spatial frequency spectrum and the depth. Theoretically, at least two images of the same scene captured with different focal planes are required to measure an object's depth without ambiguity. Recently, a special family of DfD algorithms, depth from differential defocus, demonstrated unprecedentedly low computational cost by leveraging simple, mathematical relationships between the differential change of image defocus and the object depth and has been validated by real-world prototypes. Despite being computationally efficient, a fundamental drawback of these analytical DfD algorithms is the degeneracy, i.e., unreliable depth estimations at textureless regions of the images due to the lack of defocus cues. Fortunately, it is possible to predict where the degeneracies will happen given an image and the unreliable depth estimations in such areas can be removed from the final depth estimation.

In contrast, learning-based models utilize a deep neural network architecture to learn the mapping from the defocused images to the depth values from data. Compared to analytical non-learning-based solutions, this class of methods achieves higher quality, dense depth maps at higher computational costs. For example, a recent analytical DfD algorithm costs fewer than 1k floating point operations (FLOPs) per pixel, while a U-Net-based DfD algorithm uses 300k FLOPs per pixel. The learning-based DfD algorithms bypass the degeneracy issue by implicitly learning to fill depth values in textureless regions based on neighboring depth estimations. Thanks to recent advances in optical technologies, the design of the blur kernel has also been incorporated into the learning process so that the optical design and the DfD algorithm are optimized in an end-to-end fashion. The jointly-optimized systems typically demonstrate more accurate depth estimation than systems with pre-determined, fixed optics.

Extracting depth information from photon-limited (e.g., very low light exposure), defocused images is challenging because DfD algorithms rely on accurate estimation of defocus blur, which is fundamentally sensitive to image noise. This sensitivity to image noise is a fundamentally challenging problem in DfD methods because the defocus information needs to be extracted from the spatial gradients of the images, which becomes increasingly sensitive to noise when the image defocus is significant. Previously known DfD algorithms have typically assumed a relatively low noise level in experiments. When necessary, these methods simply suppress the noise by averaging multiple frames or binning pixels, and some use specially designed filters to locally attenuate the perturbation of the noise.

In recent years, a series of efforts have utilized a patch representation, called field-of-junction (FoJ), to regularize boundary detection from images. FoJ has demonstrated good robustness in detecting boundary structures from images at an extremely low signal-to-noise ratio. However, FoJ does not model boundary smoothness, and the boundary structures it can represent are limited to lines, edges, and junctions. If a more general patch representation incorporating boundary smoothness and more sophisticated boundary structures could be developed, it could be utilized to detect the defocus along boundaries robustly in the presence of significant noise.

Considering the many and varied potential useful applications of DfD methods, most of which will include dark environments, there is an ongoing desire for DfD algorithms and methods that are robust to photon-limited, noisy images.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods of measuring the depth of an object from two-dimensional images of the object.

According to a nonlimiting aspect, such a method includes measuring first patch information from a first image in an image capture plane of an edge boundary of an object. The first image includes the edge boundary at a first state of defocus, and the first patch information includes boundaries, color, and blurriness of the first image. The method further includes measuring second patch information from a second image in the image capture plane of the edge boundary. The second image includes the edge boundary at a second state of defocus different than the first state of defocus, and the second patch information includes boundaries, color, and blurriness of the second image. A distance of the object from the image capture plane is then measured from differences in the first patch information and the second patch information based on differences of the edge boundary between the first state of defocus and the second state of defocus.

Technical aspects of methods as described above preferably include the ability to robustly measure object depths from photon-limited images along defocused boundaries.

These and other aspects, arrangements, features, and/or technical effects will become apparent upon detailed inspection of the figures and the following description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 depicts an image formation model representing a deformable lens that can change its optical power from ρ− to ρ+. The point spread function of a fixed target changes its width from σ− to σ+ according to the thin-lens law.

FIGS. 2A and 2B represent certain aspects of a method that utilizes an image patch representation the scope of the present invention. The image patch representations relate to a number (l) of vertically-stacked, constant-color wedges, wherein l=2. In FIG. 2A, the ith wedge is parameterized by vertex position (xᵢ, yᵢ), starting and ending angle (Θᵢ₁, Θᵢ₂), color cᵢ, and boundary smoothness ηᵢ. The rendering of the patch is through the alpha compositing of the wedges. FIG. 2B illustrates the method as capable of representing a variety of boundary structures with various boundary smoothness.

FIGS. 3A through 3F represent visualizations from a sample image patch representation. FIG. 3A represents an unsigned distance map to the nearest unoccluded boundary, u (x;ψ). FIG. 3B represents a corresponding boundary center map, b (x;ψ,δ). FIG. 3C represents a signed distance map of the bottom wedge, α₁ (x;ψ). FIG. 3D represents an α-map of the bottom wedge, α₁ (x;ψ). FIG. 3E represents a color map of the patch, c (x;ψ). FIG. 3F represents a magnitude of color derivative map of the patch, c′(x;ψ).

FIG. 4 represents a framework of the method, including a local stage that comprises residual blocks and predicts a representation for each patch locally, and a global stage that comprises a transformer encoder and refines the representation for all patches globally. The framework combines the per-patch representations and outputs a global boundary map, a color map for each optical power, and a depth map.

FIGS. 5A through 5F depict examples of inputs and global outputs of the method. FIG. 5A depicts a noisy input image pair L with different optical power ρ_{±}. FIG. 5B depicts a global boundary center map B (x). FIG. 5C depicts a pair of global color maps C_{±}(x). FIG. 5D depicts a global sparse depth map Z (x). FIG. 5E depicts sharpened and refocused color maps. FIG. 5F depicts a global confidence map F (x).

FIGS. 6A through 6I show depth maps generated for two real-world images, and compare the real-world images to a reference depth map, the results of the image patch representation disclosed herein, and results obtained using algorithms of six pre-existing methods. Inset numbers are RMSEs (cm) with respect to the valid pixels in the reference depth map

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the claims, and not the detailed description, are intended to recite what are believed to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

The following discussion describes a method that preferably includes the ability to robustly measure object depths from photon-limited images along defocused boundaries. Such methods utilize an image patch representation that explicitly stores and visualizes a rich set of low-level patch information, including boundaries, color, and blurriness. The method further utilizes a deep neural network architecture to predict the image patch representation from a pair of differently defocused images, from which depth can be analytically calculated using a derived DfD algorithm. Investigations leading to the invention evidenced that the method is able to achieve high depth estimation accuracy on photon-limited images compared to a broad range of state-of-the-art DfD methods.

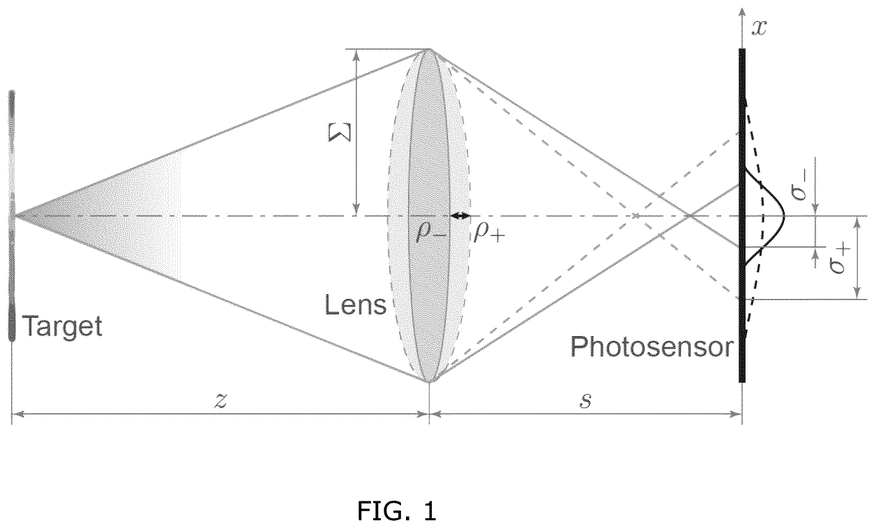

FIG. 1 represents an image formation system having a wide-aperture deformable lens that is represented as imaging a parallel target. The deformable lens is further represented as capable of changing its optical power from ρ− to ρ+. Under paraxial approximation, an image captured with a photosensor is mathematically the convolution of the point spread function (PSF) k(x) and the pinhole image Q(x):

$$I ( x ) = Q ( x ) * k ( x , σ ( z ) ) . \qquad ( 1 )$$

where x is the 2D position on the photosensor. It is assumed that the PSF has a Gaussian intensity profile and the defocus process follows the thin lens law. In FIG. 1, Σ represents the standard deviation of the Gaussian aperture function, ρ is the dioptric power of the lens, and s is the separation between the photosensor and the lens.

To approximate textures in the pinhole image Q(x) of different sharpness, each small patch P of the pinhole image Q(x) is modeled as the convolution of a Gaussian kernel k(x;ξ) with standard deviation and a piecewise step function Q̅(x):

$$Q ( x ) = \overline{Q} ( x ) * k ( x , ξ ) , x ∈ P . \qquad ( 2 )$$

Combining with Equation (1), the Captured Image I(x) can be Represented as:

$$I ( x ) = \overline{Q} ( x ) * k ( x , \sqrt{σ {( z )}^{2} + {ξ}^{2}} ) , \qquad ( 3 )$$

In reference again to FIG. 1, the deformable lens can dynamically vary its optical power so that the system can sequentially capture two images of a static scene, I₊ and I₋, with different optical powers, ρ+ and ρ−. By estimating the smoothness value of a corresponding boundary in a patch P, η+ and η−, the mathematical relationships are:

$$\sqrt{{η}_{\pm }^{2} - {ξ}^{2}} = \sum [ ( \frac{1}{z} - {ρ}_{\pm } ) s + 1 ] . \qquad ( 4 )$$

By combining Equations 3 and 4 to cancel out ξ, the following Equation 5 (“DfD equation”) is obtained to calculate the depth of the boundary given a pair of estimated smoothness η+ and η−:

$$z ( {η}_{+} , {η}_{-} ) = \frac{2 {\sum }^{2} {s}^{2} ( {ρ}_{-} - {ρ}_{+} )}{{η}_{+}^{2} - {η}_{-}^{2} - {\sum }^{2} s ( {ρ}_{+} - {ρ}_{-} ) ( s {ρ}_{+} + s {ρ}_{-} - 2 )} \qquad ( 5 )$$

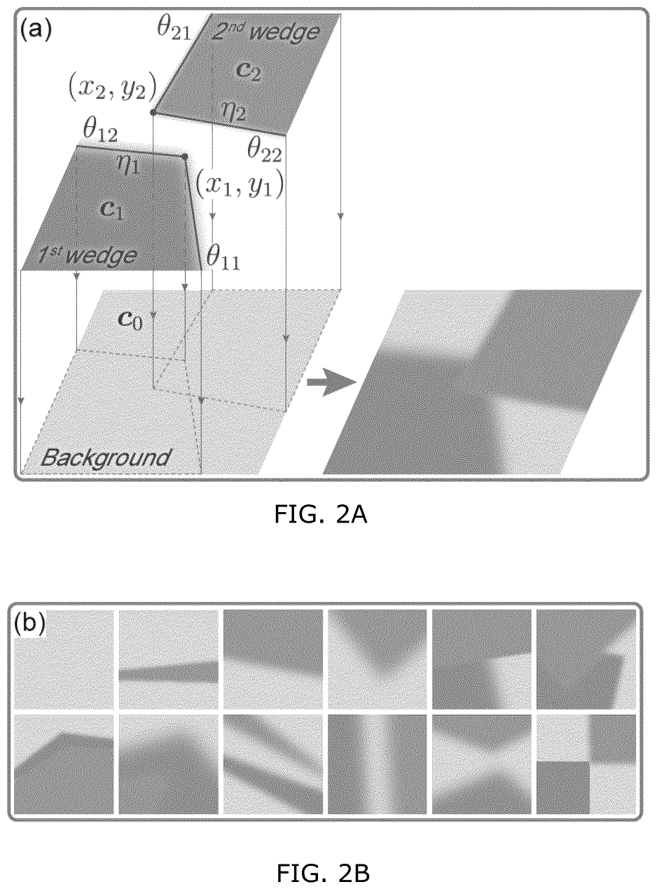

As discussed below, the method utilizes the image patch representation that represents an image patch as an alpha compositing of a number (1) of vertically-stacked, constant-color wedges with smooth boundaries. As illustrated in FIG. 2A, each patch is modeled by a set of parameters,

$$Ψ = ( \{ {p}_{i} , {θ}_{i} , {c}_{i} , {η}_{i} , i = 1 , 2 , ... , l \} , {c}_{0} ) . \qquad ( 6 )$$

The tuple (pᵢ,θᵢ,cᵢ,ηᵢ) parameterize the ith wedge in the patch, with pᵢ=(xᵢ,yᵢ) representing the vertex, θᵢ=(θᵢ₁,θᵢ₂) denoting the starting and ending angle, cᵢ indicating the RGB color, and ηᵢ recording the smoothness of the boundary. The wedge with a large index is in the front. The vector c₀ represents the RGB color of the background. As shown in FIG. 2B, this representation can model various boundary structures and smoothness.

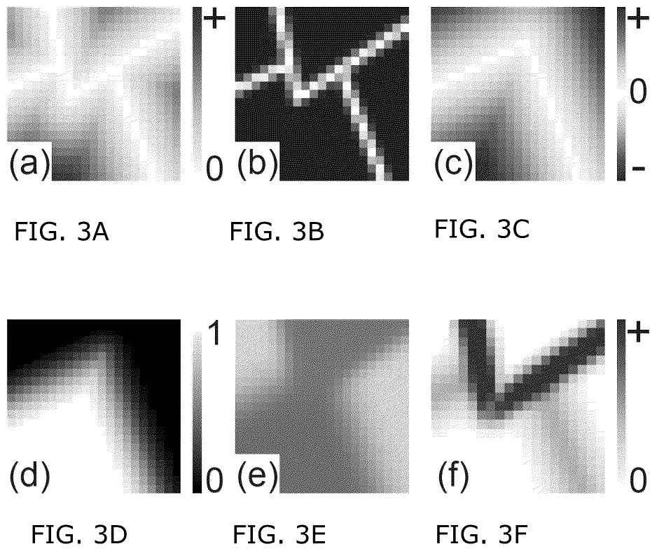

Given an image patch representation of a patch Ψ, several types of auxiliary visualizations can be generated. First, the boundary center map b(x;Ψ,δ) highlights the center of each unoccluded boundary in the patch (FIG. 3B). The boundary center map is computed via:

$$b ( x ; Ψ , δ ) = exp ( - \frac{{( u ( x ; Ψ ) )}^{2}}{{δ}^{2}} ) , \qquad ( 7 )$$

where δ is a hyperparameter that controls the stroke of the visualized boundaries and u(x;ψ) is an unsigned distance map to the nearest unoccluded boundary center for each pixel. FIG. 3A indicates a distance map to generate what is shown in FIG. 3B.

Second, the color map c(x;ψ) is the rendering of the stacked, colored wedges according to their boundary smoothness and occlusion. The color map can be computed via alpha compositing:

$$c ( x ; Ψ ) = {\sum }_{i = 0}^{l} {c}_{i} {α}_{l \to i} ( x ; Ψ ) ; \qquad ( 8 )$$

Where α_{l→i}(x;Ψ) is the Collective α-Map from the lth to the ith Wedge:

$${α}_{l \to i} ( x ; Ψ ) = {α}_{i} ( x ; Ψ ) {\prod }_{j = i + 1}^{l} ( 1 - {α}_{j} ( x ; Ψ ) ) . \qquad ( 9 )$$

The Term αᵢ(x;Ψ) is the α-Map of the Ith Wedge:

$${α}_{i} ( x ; Ψ ) = \frac{1}{2} [ 1 + erf ( \frac{{d}_{i} ( x ; Ψ )}{\sqrt{2} {η}_{i}} ) ] , \qquad ( 10 )$$

where erf(·) indicates the Gaussian error function, dᵢ(x;Ψ) denotes the signed distance map of the ith wedge (FIG. 3C), and ηᵢ is the boundary smoothness of the wedge. FIG. 3E shows a sample color map that corresponds to the boundary center map in FIG. 3B.

Besides the boundary center map and the color map, the image patch representation also enables a color derivative map c′(x;Ψ) that highlights the boundary smoothness. The color derivative map is computed as the color map's response to the Sobel operator:

$${c}^{′} ( x ; Ψ ) = \sqrt{{( c ( x ; Ψ ) * {G}_{x} )}^{2} + {( c ( x ; Ψ ) * {G}_{y} )}^{2}} , \qquad ( 11 )$$

where Gₓ and G_{y} are the Sobel kernels in x and y directions. A sample color derivative map is visualized in FIG. 3F.

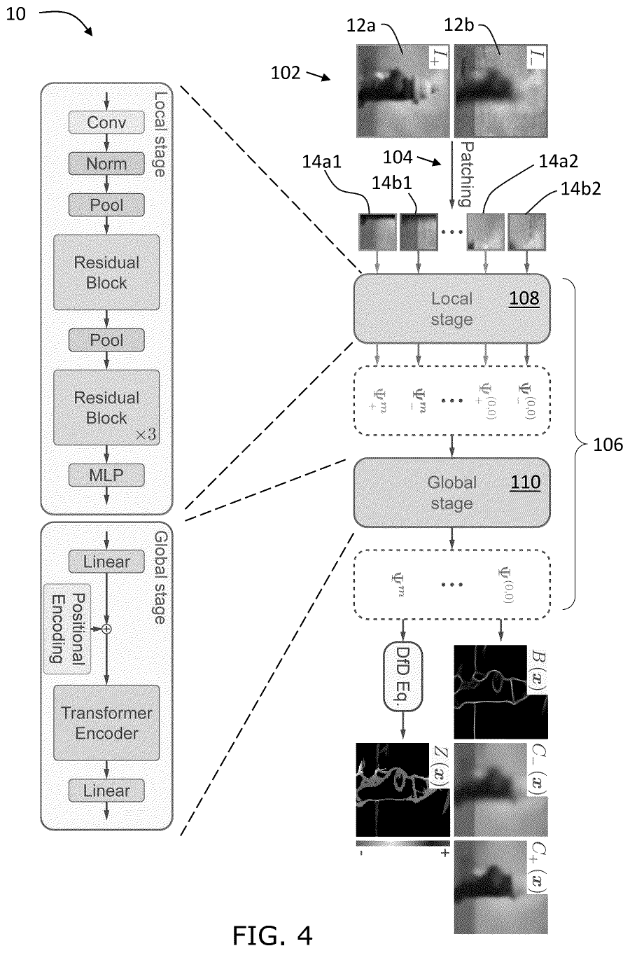

FIG. 4 represents a DfD algorithm 10 based on the image patch representation according to the present disclosure for estimating object depth from a pair of defocused images. At 102, the input to the algorithm 10 comprises is a pair of differently defocused images 12a and 12b of a static scene, I₊,I₋∈R^{H×W×k}. The images 12a and 12b are substantially identical with the only significant difference being that of the focus, that is, the amount of defocus, for each image 12a and 12b. For simplicity of notation, I_{±} is used in equations below to represent the pair of images 12a and 12b. At 104, each image 12a and 12b undergoes a patching process in which the image 12a is divided into a set of uniform-size, overlapping patches 14al and 14a2, and the image 12b is divided into a set of uniform-size, overlapping patches 14b1 and 14b2, in which each patch 14al and 14a2 is a smaller section of the overall image 12a and each patch 14b1 and 14b2 is a smaller section of the overall image 12b. At 106, the algorithm 10 estimates the per-patch representations from the defocused images 12a and 12b. This estimation is conducted in two stages: a local stage 108 and a global stage 110. In the local stage 108, the image patch representation of each patch 14a1, 14a2, 14b1, and 14b2 is calculated based only on the local information for that particular patch. In the global state 110, the model leverages a transformer encoder to take in all of the image patch representations and refine them according to several consistency constraints.

The image patch representation of each patch 14al, 14a2, 14b1, and 14b2 is independently predicted using a convolutional neural network (CNN) based architecture. Given a patch, P∈R^{h×x×k}, the CNN predicts a part of its image patch representation, including the vertex locations {pᵢ}, the angles {θᵢ}, and the boundary smoothness {ηᵢ}. Then, it computes the color information {cᵢ}using these predicted parameters and the patch P via ridge regression:

$$[ \begin{matrix}{c}_{0} \\ ⋮ \\ {c}_{l}\end{matrix} ] = {( {A}^{⊤} A + λ {𝕀}_{( l + 1 ) \times ( l + 1 )} )}^{- 1} [ \begin{matrix}{α}_{l \to 0} ( x ) \cdot P ( x ) \\ ⋮ \\ {α}_{l \to l} ( x ) \cdot P ( x )\end{matrix} ] , \qquad ( 12 )$$

where α_{l→0} (x) is the collective α-map described in Equation (9) and α_{l→i} (x)·P (x) indicates the channel-wise dot product between the collective α-map and the patch, and the matrix A=[α_{l→0}(x) . . . α_{l→1}(x)].

The local stage estimates the image patch representation of each patch 14al, 14a2, 14b1, and 14b2 purely based on the local information. For notation purposes, a patch 14a1, 14a2, 14b1, and 14b2 cropped from one of the two images 12a or 12b is denoted as, I_{±}, as P_{±}^{m}. The subscript ± represents the image 12a or 12b from which the patch 14a1, 14a2, 14b1, and 14b2 was cropped, and the superscript m=(m,n) indicates the center position of the patch 14a1, 14a2, 14b1, and 14b2 from the original image12a or 12b. The image patch representation predicted by the local stage is denoted as Ψ^{m}_{±}, as shown in FIG. 4.

In the global stage, the model leverages a transformer encoder to take in all image patch representations,

$$\{ {Ψ}_{\pm }^{m} , ∀ m \}$$

and refine them according to several consistency constraints. First, for each pair of patches corresponding to the center position m in the pair of images, the transformer encoder outputs a regularized image patch representation, ψ^{m}=(Ω^{m}, η₊^{m}, η₋^{m}):

$${Ω}^{m} = \{ {p}_{i} , {θ}_{i} , {c}_{i} , {c}_{0} , i = 1 , … , l \} , \qquad ( 13 )$$

$${η}^{{m}_{+}} = \{ {η}_{i , +} , i = 1 , … , l \} ,$$

$${η}^{{m}_{-}} = \{ {η}_{i , -} , i = 1 , … , l \} .$$

This regularized image patch representation enforces the defocus consistency, i.e., the pair of patches share the same wedge positions and colors, Ω^{m} and c₀, but different boundary smoothness as specified by

$${η}_{+}^{m} and {η}_{-}^{m} .$$

Then, using the DfD equation (Equation (5)), the depth value of each wedge can be solved from the two corresponding smoothness values ηᵢ.+,ηᵢ.−:

$${z}_{i}^{m} = z ( {η}_{i , +} , {η}_{i ,} - ) . \qquad ( 14 )$$

The transformer encoder is trained to also promote consistency among neighboring patches in terms of boundary center maps, color maps, and color derivative maps.

Finally, the model calculates a global boundary center map, a global color map for each optical power, and a global depth image by aggregating all patch-wise image patch representations. The global boundary center map B (x) is computed by averaging all per-patch boundary maps:

$$B ( x ) = \frac{1}{\vert {P}_{\pm }^{m} ∋ x \vert} {\sum }_{{P}_{\pm }^{m} ∋ x} b ( x - m ; {Ω}^{m} , δ ) , \qquad ( 15 )$$

where P_{±}^{m}∃x indicates all patches centered at m that contain pixel x and

$$\vert {P}_{\pm }^{m} ∋ x \vert$$

denotes the number of such patches. The global color map C (x) is computed similarly by averaging the local color maps, but it can be augmented with different smoothness values for each wedge:

$$C ( x ) = \frac{1}{\vert {P}_{\pm }^{m} ∋ x \vert} {\sum }_{{P}_{\pm }^{m} ∋ x} c ( x - m ; \{ {Ω}^{m} , {η}^{m} \} ) . \qquad ( 16 )$$

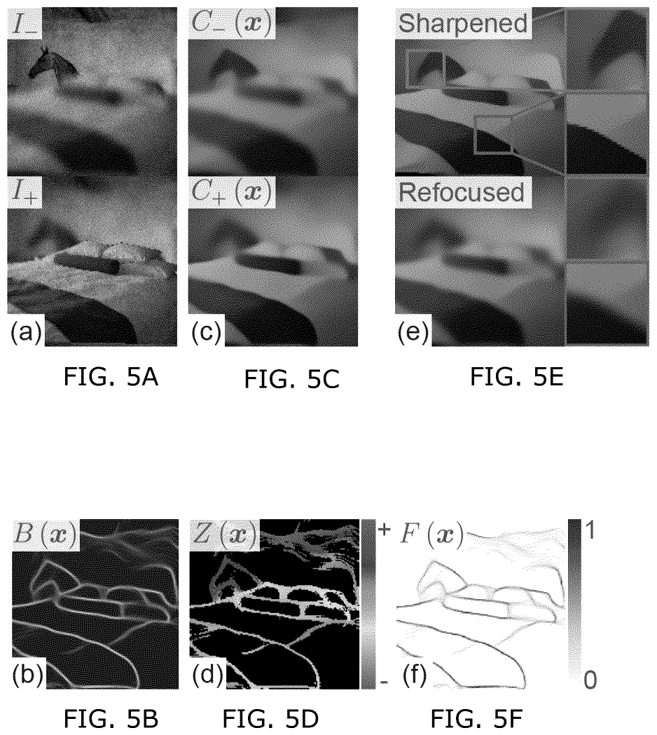

The parameter η^{m} denotes the smoothness values for all wedges in the patch. When setting the smoothness value η^{m}=η^{m}_{±}, the generated color map corresponds to the input image pairs I_{±}. Furthermore, the model can generate a refocused or sharpened color map by setting η^{m} to different values. Examples are shown in FIG. 5E. From the global color map C(x), the global color-derivative map C′(x) can also be calculated by performing the Sobel filtering as in Equation (11).

The global sparse depth map Z (x) visualizes the depth values along the boundary centers:

$$Z ( x ) = \frac{{\sum }_{{P}_{\pm }^{m} ∋ x} {\sum }_{i = 1}^{l} H ( {b}_{i} ( x - m ; {Ω}^{m} , δ ) - τ ) \cdot {z}_{i}^{m}}{{\sum }_{{P}_{\pm }^{m} ∋ x} H ( b ( x - m ; {Ω}^{m} , δ ) - τ )} , \qquad ( 17 )$$

where H (·) is the Heaviside step function, bᵢ (x;Ω^{m}, δ)=b (x;Ω^{m}, δ)·Mᵢ(x) is the unoccluded boundary center of the ith wedge (Mᵢ (x) is the mask for the unoccluded ith wedge, τ is a hyperparameter to control the coverage of the depth value, zᵢ^{m} is the estimated depth value of the ith wedge in patch P_{±}^{m} according to Equation (14). The model also outputs a global confidence map that predicts and filters unreliable boundary and depth estimations. It is calculated via:

$$F ( x ) = \frac{1}{\vert {P}_{\pm }^{m} ∋ x \vert} {\sum }_{{P}_{\pm }^{m} ∋ x} H ( b ( x - m ; {Ω}^{m} , δ ) - τ ) . \qquad ( 18 )$$

FIG. 5 visualizes the global maps generated from the DfD algorithm of a sample synthesized scene.

A modular learning scheme was designed to independently train the local and global stages of the model. First, the parameters of the CNN in the local stage were optimized using the following loss function:

$${ℒ}_{local} = {\sum }_{i = 1}^{3} {β}_{i} {𝔼}_{m} ( {l}_{i} ) , \qquad ( 19 )$$

where the symbol Eₘ denotes the expectation over all patches in an image. The loss function consists of three terms that comprehensively penalize the color error, smoothness error, and boundary localization error:

$$\begin{matrix}{l}_{1} = {}^{X} {‖ c ( x ; {Ψ}_{k}^{m} ) - {P}_{k}^{m} ( x ) ‖}^{2} & ( color error ) , \\ {l}_{2} = {\sum }_{k = \pm } {‖ {c}^{′} ( x ; {Ψ}_{k}^{m} ) - {P}_{k}^{m , ′} ( x ) ‖}^{2} & ( smoothness error ) , \\ {l}_{3} = {\sum }_{k = \pm } b ( x ; {Ψ}_{\pm }^{m} ) \cdot {u}^{m} ( x ) & ( boundary localization ) ,\end{matrix}$$

where the terms

$${P}_{k}^{m} ( x ) and {P}_{k}^{m , ′} ( x )$$

indicate the noiseless image patch and its derivative map from Gabor filtering, and u^{m} represents the unsigned distance map to the nearest true boundaries in the patch.

After the local stage converges, the transformer encoder is trained in the global stage with a fixed local stage using a comprehensive loss function that utilizes seven terms:

$${ℒ}_{global} = {\sum }_{i = 1}^{7} {γ}_{i} {𝔼}_{{I}_{\pm } , m} ( {g}_{i} ) , \qquad ( 20 )$$

where E_{I±m} denotes the expectation over all image pairs I_{±} in the training set and all corresponding patches of each image pair. Seven loss terms gᵢ, detailed in Equation (21) below, comprehensively penalize the prediction error and inconsistency among neighboring patches regarding colors, boundary locations, boundary smoothness, and depth.

$$( 21 )$$

$$\begin{matrix}{g}_{1} = ‖ c ( x ; \{ {Ω}^{m} , {η}^{m} ) \} - {P}_{clean}^{m} ( x ) {‖}^{2} & ( color error ) , \\ {g}_{2} = ‖ c ( x ; \{ {Ω}^{m} , {η}^{m} ) \} - {C}^{m} ( x ) {‖}^{2} & ( color consistency ) , \\ {g}_{3} = ‖ b ( x ; \{ {Ω}^{m} , δ ) \} - {B}^{m} ( x ) {‖}^{2} & ( boundary consistency ) , \\ {g}_{4} = ‖ {c}^{′} ( x ; \{ {Ω}^{m} , {η}^{m} ) \} - {P}_{clean}^{m , ′} ( x ) {‖}^{2} & ( smoothness error ) , \\ {g}_{5} = ‖ {c}^{′} ( x ; \{ {Ω}^{m} , {η}^{m} ) \} - {C}^{m , ′} ( x ) {‖}^{2} & ( smoothness consistency ) , \\ {g}_{6} = b ( x ; {Ω}^{m} , δ ) \cdot {u}^{m} ( x ) & ( boundary localization ) , \\ {g}_{7} = {‖ {\sum }_{i = 1}^{l} H ( {b}_{i} ( x ; {Ω}^{m} , δ ) - τ ) \cdot {z}_{i}^{m} - {Z}^{* , m} ( x ) ‖}^{2} & ( depth error ) ,\end{matrix}$$

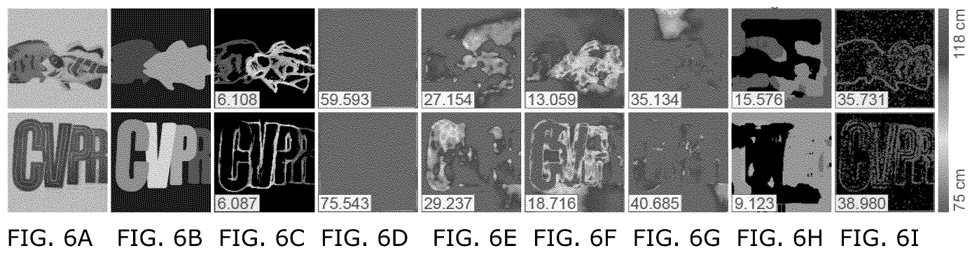

Results obtained using the methodology described above were quantitatively compared with results obtained with various state-of-the-art DfD algorithms, including both analytical and learning-based. For this purpose, a prototype camera was constructed to have a deformable lens, similar to a camera reported in Guo et al., “Focal track: Depth and accommodation with oscillating lens deformation,” Proceedings of the IEEE international conference on computer vision, pages 966-974, 2017. The camera was used to capture low-light, differently defocused image pairs or stacks to test the algorithms' performance on real-world data. FIG. 6A shows two real-world scenes used in the comparison, FIG. 6B are two corresponding reference depth maps used to enable the quantitative comparisons, FIG. 6C are two corresponding depth maps obtained with the methodology disclosed herein, and FIGS. 6D through 6FI are corresponding sets of depth maps obtained with different pre-existing algorithms. Inset numbers are RMSE values with respect to the valid pixels in the reference depth map, and evidence that the depth maps from the disclosed methodology demonstrated the highest visual quality.

In view of the above, it can be appreciated that the method disclosed herein enables robust depth maps to be obtained from pairs of images of a static scene that were captured at different focal lengths, such that the captured pairs of images share the same structure but have different smoothness at the boundaries of various edges in the scene due to differences in defocus. The method estimates the smoothness values of the corresponding boundaries, from which the depth value along the boundary can be calculated.

According to a further aspect, a parametrized representation is utilized that simultaneously models the color, boundary, and blurriness of a noisy image patch clipping.

According to another aspect, a DfD algorithm is provided that associates the smoothness of the corresponding boundary in a pair of differently defocused images to depth.

According to yet another aspect, a deep neural network architecture can be utilized to robustly estimate object depth along boundaries from a pair of defocused images with 4× higher noise level than has been possible using pre-existing DfD algorithms. The algorithm 10 and method disclosed herein were shown to demonstrate good robustness of estimating depth from photon-limited images. Investigations showed that the algorithm and method are capable of providing high accuracy in depth prediction using noisy, photon-limited input images as compared to depth predictions obtained from previously known DfD algorithms in both simulation and real-world experiments.

The DfD algorithm 10 and method disclosed herein can provide several advantages over conventional DfD algorithms and systems. The present system can be trained using naive, synthesized images with basic geometries and effectively estimate depths on real-world captured images without significant fine-tuning. The image patch representation is multifunctional, that is, besides accurate depth prediction, the method output is preferably capable of simultaneously generating a boundary map including edges of all smoothness and/or a noiseless color map.

As previously noted above, though the foregoing detailed description describes certain aspects of one or more particular embodiments of the invention, alternatives could be adopted by one skilled in the art. As such, and again as was previously noted, it should be understood that the invention is not necessarily limited to any particular embodiment described herein or illustrated in the drawings.

1. A method of measuring object depth from two-dimensional images, the method comprising:
measuring first patch information from a first image in an image capture plane of an edge boundary of an object, wherein the first image includes the edge boundary at a first state of defocus, the first patch information including boundaries, color, and blurriness of the first image;
measuring second patch information from a second image in the image capture plane of the edge boundary, wherein the second image includes the edge boundary at a second state of defocus different than the first state of defocus, the second patch information including boundaries, color, and blurriness of the second image; and
measuring a distance of the object from the image capture plane from differences in the first patch information and the second patch information based on differences of the edge boundary between the first state of defocus and the second state of defocus.

2. The method of claim 1, wherein the step of measuring the distance comprises calculating a predicted image patch representation from the first patch information and the second patch information using a deep neural network.

3. The method of claim 2, wherein the step of measuring the distance comprises calculating the distance from the predicted image patch representation using a depth-from-defocus relation.

4. The method of claim 1, wherein the step of calculating a predicted image patch representation comprises modeling an image patch as a stack of partially occluded wedges.

5. The method of claim 4, wherein the modeling comprises parameterizing each partially occluded wedge by its vertex, color, and boundary blurriness.

6. The method of claim 1, the method further comprising:
capturing the first image of a static scene including the edge boundary of the object through a lens set at a first focal length, wherein the first image has a first smoothness at the edge boundary due to the first state of defocus; and
capturing the second image of the static scene including the edge boundary of the object through the lens set at a second focal length, wherein the second image has a second smoothness at the edge boundary due to the second state of defocus.

7. The method of claim 1, wherein at least one of the first image and the second image is a photon-limited image.

8. The method of claim 1, wherein the first and second images are captured with a camera having a deformable lens.

9. An image patch representation comprising a parameterized representation that simultaneously models color, boundary, and blurriness of a noisy image patch.
